(19) United States
(12) Patent Application Publication
(10) Pub. No.: US 2026/0230234 A1
(43) Pub. Date: Aug. 6, 2026

(54) MULTI-LEVEL FORWARD ERROR CORRECTION WITH LINK LEVEL RETRANSMISSION

(71) Applicant: Hewlett Packard Enterprise Development LP, Spring, TX (US)

(72) Inventors: Frank R. Dropps, Annandale, MN (US); Mark Ronald Sikkink, Chippewa Falls, WI (US); Derek Alan Sherlock, Ft Collins, CO (US)

(21) Appl. No.: 19/043,098

(22) Filed: Jan. 31, 2025

(51) Int. Cl. H04L 1/1812

(52) U.S. Cl. CPC H04L 1/1816

(57) ABSTRACT

One aspect of the instant application provides a system and method for improving data transmission reliability. During operation, a network node may encode a first data block using first and second Forward Error Correction (FEC) codes to generate, respectively, first and second sets of parity symbols and transmit, over a data link, the first data block accompanied by the first set of parity symbols to a link partner. In response to receiving, from the link partner, a request for the second set of parity symbols, the network node may transmit the second set of parity symbols to the link partner. In response to receiving, from the link partner, a retransmission request, the network node may retransmit the first data block accompanied by the first set of parity symbols to the link partner.

### BACKGROUND

### Field

This disclosure relates to a system and method for improving the reliability of communication links. More specifically, this disclosure relates to combining multi-level Forward Error Correction (FEC) with Link-Level Retransmission (LLR) to reduce the effective Bit Error Rate (BER) of a communication link while reducing the impact on effective link bandwidth.

### Related Art

The ever-increasing demands of advanced Artificial Intelligence (AI) and High-Performance Computing (HPC) systems call for progressively greater network bandwidth. However, as link data rates rise to meet these demands, signal integrity may suffer due to higher losses and reduced noise immunity, resulting in elevated Bit Error Ratios (BERs). Existing mitigation strategies against higher BER include Forward Error Correction (FEC) and Link Level Retransmission (LLR). FEC requires a transmitter to add parity symbols (known as error-correction codes) to the original message to allow the receiver to detect and potentially correct errors, whereas LLR requires the transmitter to retransmit data if errors are detected. Both methods, however, reduce the effective bandwidth of a communication link by transmitting additional data (i.e., the parity symbols in the case of FEC and the retransmitted data in the case of LLR).

### BRIEF DESCRIPTION OF THE FIGURES

FIGS. 1A-1C illustrate data flow examples on a communication link, according to one aspect of the instant application.

FIG. 2 illustrates the simplified block diagram of the frontend of a communication link, according to one aspect of the instant application.

FIG. 3 illustrates a receive (RX) path example within a network node, according to one aspect of the instant application.

FIG. 4 illustrates a transmit (TX) path example within a network node, according to one aspect of the instant application.

FIG. 5 presents a flowchart illustrating an example process for transmitting data on a communication link implementing multi-level FEC and link-level retransmission (LLR), according to one aspect of the instant application.

FIG. 6 presents a flowchart illustrating an example process for receiving data on a communication link implementing multi-level FEC and link-level retransmission (LLR), according to one aspect of the instant application.

FIG. 7 illustrates an example network node implementing multi-level FEC and LLR, according to one aspect of the instant disclosure.

In the figures, like reference numerals refer to the same figure elements.

### DETAILED DESCRIPTION

Forward Error Correction (FEC) has been widely used in digital communication systems to improve data reliability. In a data link implementing FEC, the sender encodes the original user data (called information bits) using an error correction algorithm and transmits the coded bits (which include redundant data) to the receiver. If some bits are corrupted during transmission (e.g., due to noise, interference, or signal degradation), the receiver can use the redundant data to reconstruct the original user data. The maximum proportion of errors that can be corrected by an FEC scheme depends on the strengths of the FEC code. Stronger FEC codes have a larger error-correction capability but also tend to have a lower code rate (i.e., the ratio between the number of information bits and the total number of coded bits). The coding gain provided by stronger FEC is offset by a corresponding increase in the line rate required to accommodate the extra code bits. When FEC fails to correct detected errors, retransmission is needed, delaying new data transmission and consuming link bandwidth. One existing approach to improve the FEC's ability to correct burst errors is to use interleaved FEC, where the order of the to-be-transmitted bits or symbols is rearranged. However, interleaving increases the FEC latency.

To improve the FEC performance without significantly impacting the link bandwidth, some aspects of this disclosure provide a solution that combines multi-level FEC with LLR. The multi-level FEC encoding scheme may include encoding, at the transmitter, the user data using both an inner (or lower level) FEC code and an outer (or higher level) FEC code. The transmitter may initially send the user data along with the inner FEC parity symbols to the receiver, which may detect and correct possible errors in the received data based on the inner FEC parity symbols. The transmitter may send the outer FEC parity symbols in response to the inner FEC failing to correct all errors in the received data. If both the inner and outer FECs fail to correct the errors, an LLR operation may be performed to recover the correct data. In some aspects, FEC codeword interleaving may also be employed to improve burst error correction.

In some aspects, to further improve efficiency, this multi-level FEC encoding with LLR scheme may be applied to multiple independent data streams. A data stream may include a sequence of related packets that all have the same source and destination endpoints and may also have other similar properties such as belonging to the same traffic class or being part of a single communication, for example, as in the case of a TCP flow. Packets within the same data stream may be ordered, whereas packets belonging to different data streams would have no ordering constraints between them at any network layer.

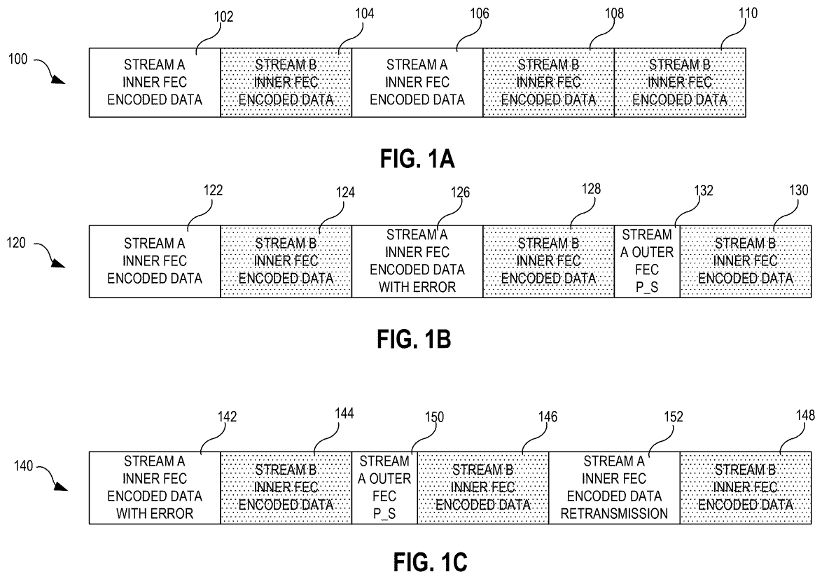

FIGS. 1A-1C illustrate data flow examples on a communication link, according to one aspect of the instant application. In these examples, each data flow includes two independent data streams, Stream A and Stream B. In practice, any number of independent data streams present in the traffic on the communication link may participate (e.g., being protected by a multi-level FEC code), up to an implementation-specific limit. The inclusion of an additional data stream provides significant benefits. However, even the extreme case of a single data stream can still provide certain latency and bandwidth benefits.

In FIG. 1A, a data flow 100 on a communication link may include two independent data streams, Data Stream A and Data Stream B, with each data stream including a plurality of data blocks (e.g., data blocks 102-110). Each data block may include one or more inner FEC codewords, with each inner FEC codeword including both the original user data and the inner FEC parity symbols. Note that there are no ordering constraints between these two data streams, and the FEC codewords belonging to each data stream may be transmitted as they become available. In this example, data blocks 102 and 106 belong to Data Stream A, and data blocks 104, 108, and 110 belong to Data Stream B, with Stream B data block 104 transmitted between Stream A data blocks 102 and 106. However, the order among data blocks within the same data stream may need to be maintained (i.e., they are to be transmitted and processed according to a predetermined order). In the example shown in FIG. 1A, data blocks in both streams may include no error or a small number of errors such that the inner FEC is sufficient to correct all detected errors. Therefore, both data streams are transmitted/received as normal without requiring the transmission of the outer FEC parity symbols or the retransmission of the inner FEC codewords.

In FIG. 1B, a data flow 120 includes independently transmitted Data Stream A and Data Stream B, with each data stream including a plurality of data blocks (e.g., data blocks 122-130). In this example, data blocks 122 and 126 belong to Data Stream A, and data blocks 124, 128, and 120 belong to Data Stream B. In FIG. 1B, data block 126 in Data Stream A includes errors that cannot be corrected by the inner FEC. Upon detecting the uncorrected errors, the receiver may request the transmitter to transmit the parity symbols of the outer FEC encoding for the user data in data block 126, (i.e., Stream A outer FEC parity symbol (P_S) block 132). Because the receiver already has the user data, there is no need to transmit the entire outer FEC codeword, thus providing bandwidth savings. Before all errors in data block 126 are corrected, subsequent data blocks belonging to Data Stream A will not advance, but data belonging to Data Stream B (e.g., data block 128) may be transmitted as normal. In this example, the number of detected errors is small enough, such that they can all be corrected based on Stream A outer FEC P_S block 132. Therefore, there is no need for retransmission. Data Stream B, on the other hand, is sufficiently protected by the inner FEC and may be transmitted normally (i.e., no need for requesting the outer FEC parity symbols).

In FIG. 1C, a data flow 140 similarly includes Data Stream A and Data Stream B, with each data stream including a plurality of data blocks (e.g., data blocks 142-148). In this example, data block 142 belongs to Data Stream A, and data blocks 144, 146, and 148 belong to Data Stream B. Like the example shown in FIG. 1B, data flow 140 includes a data block 142 with errors that cannot be corrected by the inner FEC, and a stream A outer FEC P_S block 150 is transmitted. However, in this example, the number of errors in data block 142 exceeds the error-correction capacity of the outer FEC, thus requiring the retransmission of the user data (i.e., retransmission data block 152). While Data Stream A is processing the outer FEC decoding (e.g., based on P_S block 150) and the retransmission of the user data, Data Stream B (e.g., blocks 144 and 146) is transmitted normally. The initial data blocks (i.e., inner FEC codewords), the outer FEC parity symbols, and the retransmitted data blocks may be transmitted in an order based on availability. In the example shown in FIG. 1C, inner FEC codewords belonging to Stream B may be transmitted between the transmission of data block 142 and stream A outer FEC P_S block 150 and/or between the transmission of stream A outer FEC P_S block 150 and retransmitted data block 152.

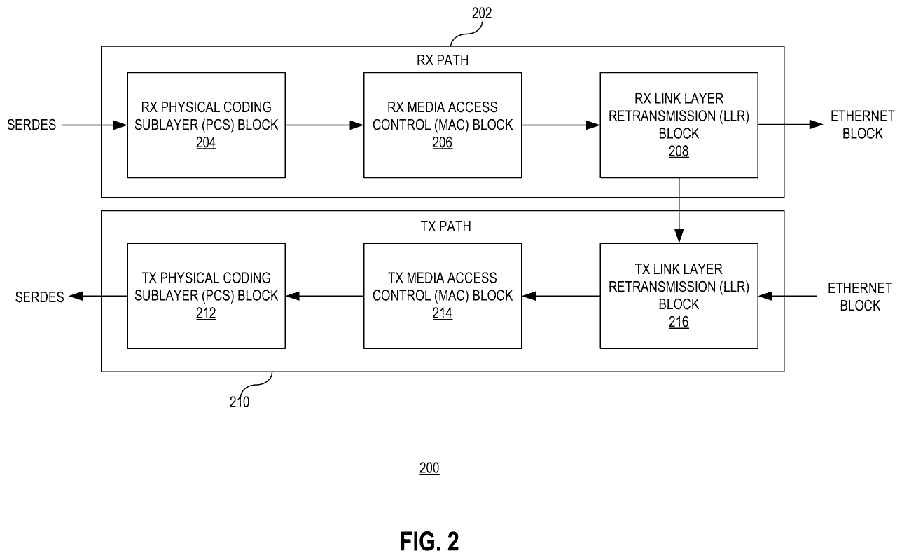

FIG. 2 illustrates the simplified block diagram of the frontend of a communication link, according to one aspect of the instant application. In FIG. 2, a frontend block 200 may include a receive (RX) path 202 and a transmit (TX) path 210. RX path 202 may include an RX physical coding sublayer (PCS) block 204, an RX media access control (MAC) block 206, and an RX LLR block 208. TX path 210 may include a TX PCS block 212, a TX MAC block 214, and a TX LLR block 216.

RX PCS block 204 is responsible for receiving data from the Serializer/Deserializer (SerDes) interface and for performing clock recovery and aligning data streams. RX PCS block 204 may also include function blocks for the 64b/66b decoding. Note that 64b/66b encoding has been widely used in high-speed data transmission to facilitate clock recovery and alignment of the data stream at the receiver. The 64b/66b decoder in RX PCS block 204 may convert encoded 66-bit blocks back into 64-bit data. The decoded 64-bit data is sent to RX MAC block 206, which is responsible for performing various functions in the MAC layer, such as frame delimiting and recognition and frame check sequence (FCS) checking. Outputs of RX MAC block 206 (e.g., the separated data frames and the FCS checking result) are sent to RX LLR block 208, which is responsible for determining whether retransmission is needed and, if needed, requesting the retransmission of user data. In this example, the communication link is an Ethernet link, and the received user data, including the retransmitted user data, may be sent to the Ethernet block for further processing.

TX PCS block 212 is responsible for sending to-be-transmitted data (which may originate from the Ethernet block) to the Serializer/Deserializer (SerDes) interface and may include function blocks for performing the 64b/66b encoding. TX MAC block 214 is responsible for appending the FCS and inserting the inter packet gap (IPG). TX LLR block 216 is responsible for performing the retransmission of the user data in response to receiving an LLR request from the link partner.

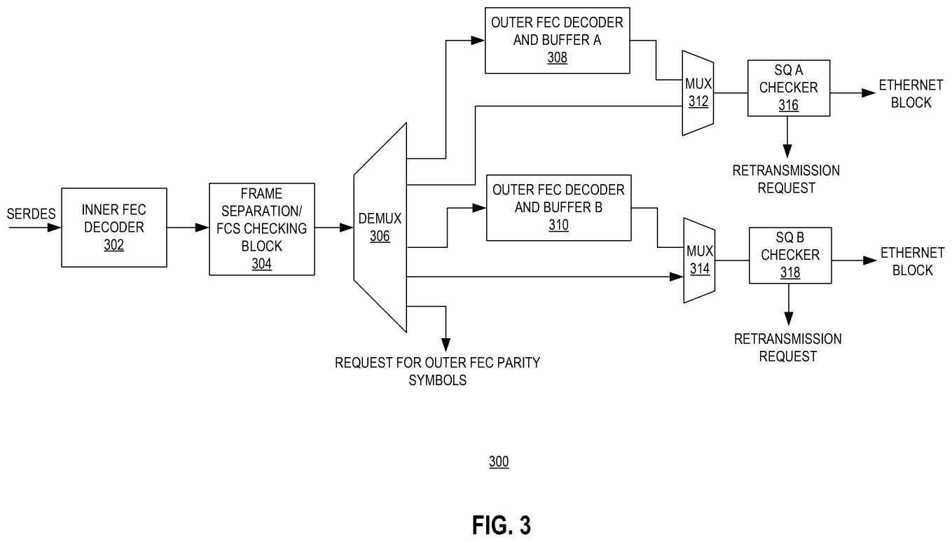

FIG. 3 illustrates a receive (RX) path example within a network node, according to one aspect of the instant application. For simplicity of illustration, function blocks not related to the FEC and LLR operations may be omitted from the drawing. In FIG. 3, receive path 300 can include an inner FEC decoder 302, a frame separation/FCS checking block 304, a demultiplexer (DEMUX) 306, an outer FEC decoder and buffer A 308, an outer FEC decoder and buffer B 310, multiplexers 312 and 314, a sequence A checker 316, and a sequence B checker 318.

The SerDes interface of the network node may receive inner FEC encoded user data and send the data to inner FEC decoder 302, which may detect and correct errors in the received data using the predetermined inner FEC algorithm. Note that logic blocks for performing the clock recovery and data deskewing and other functions are not shown in FIG. 3. After the inner FEC decoding, the user data may be sent to frame separation/FCS checking block 304 for frame separation and FCS checking. A failure in the FCS checking indicates uncorrected errors in the decoded data. The inner FEC decoding may also indicate errors that the inner FEC is not able to correct. A DEMUX 306 may separate data packets belonging to the different data streams into different paths. In this example, the received data streams include Stream A and Stream B, and packets belonging to the two streams may be sent to different paths for further processing. According to some aspects, each received packet may include a stream indicator in the packet header, which identifies to which stream the received data belongs, and DEMUX 306 may send the packets to different paths based on the stream indicator included in the packet header.

If inner FEC decoder 302 cannot correct all errors (e.g., the packets fail the subsequent FCS check or the outer FEC decoding indicates one or more uncorrectable errors), the output of DEMUX 306 may include a request for outer FEC parity symbols. Such a request may be sent, via the transmit path of the network node, to its link partner. Moreover, those packets failing the FCS check may be sent to a corresponding outer FEC decoder and buffer to wait for the outer FEC processing. If the error-containing user data belongs to Stream A, it will be sent to outer FEC decoder and buffer A 308 for buffering and outer FEC decoding; if the error-containing user data belongs to Stream B, it will be sent to outer FEC decoder and buffer B 310. These packets would remain in the buffer until the outer FEC parity symbols are received and processed.

If no error is found in the received data or inner FEC decoder 302 has corrected all errors (i.e., (e.g., the packets pass the FCS check), the user data may bypass the outer FEC decoder and buffer. More specifically, error-free data from Stream A and the output of FEC decoder and buffer A 308 may be multiplexed at MUX 312 and sent to sequence A checker 316, which performs the FCS check on the outer FEC decoded data and also checks whether the data packets in Stream A are out of order. Similarly, error-free data from Stream B and the output of FEC decoder and buffer B 310 may be multiplexed at MUX 314 and sent to sequence B checker 318. Out-of-order packets may be discarded. Moreover, if the outer FEC decoding fails to correct all errors (i.e., the decoded data fails the FCS check), sequence A checker 316 may generate a retransmission request, which may be sent to the link partner to request retransmission of the user data. In some aspects, the retransmission request may include an LLR negative acknowledgment (NACK) message. Error-free data packets that are in order may then be sent to the Ethernet block for further processing.

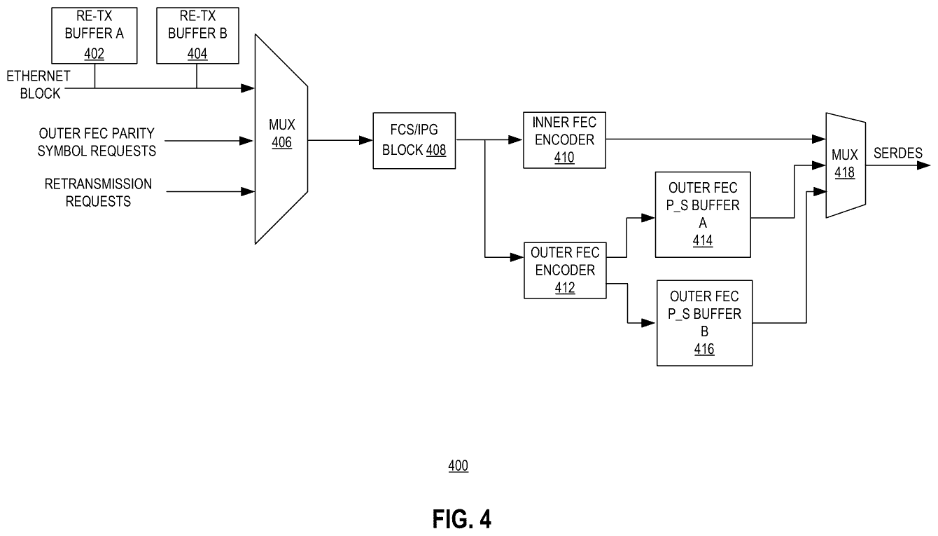

FIG. 4 illustrates in more detail the transmit (TX) path within a network node, according to one aspect of the instant application. For simplicity of illustration, function blocks not related to the FEC and LLR operations may be omitted from the drawing. For example, function blocks handling the transmission credits and others are not shown in FIG. 4. In FIG. 4, while packets from the Ethernet block are sent to a MUX 406, their copies may be stored in corresponding retransmission buffers. For example, copies of packets belonging to Stream A may be stored in retransmission buffer A 402, whereas copies of packets belonging to Stream B may be stored in retransmission buffer B 404. These copies will remain in the buffer until corresponding acknowledgments (ACKs) are received from the link partner or another indication signals that the link partner has received correct data. In addition to the data packets, MUX 406 may also receive other information (e.g., from the receive path of the network node), such as outer FEC parity symbol requests and retransmission requests.

The output of MUX 406 may be sent to FCS/IPG block 408 for appending the FCS and setting the IPG. The data may then be sent, simultaneously, to inner FEC encoder 410 and outer FEC encoder 412 for FEC encoding. In some aspects, the inner FEC code may be weaker than the outer FEC code (i.e., the inner FEC may have a higher code rate than the outer FEC). In some aspects, both the inner and outer FEC codes may include a Reed-Solomon (RS) code. In one example, the inner FEC code may include RS (520, 514) or RS (528, 514), whereas the outer FEC code may include RS (544, 514). The inner FEC codewords (i.e., the user data plus the inner FEC parity symbols) may advance to the SerDes interface via MUX 418, whereas the outer FEC parity symbols may be stored in corresponding buffers. For example, outer FEC parity symbols for Stream A may be stored in outer FEC P_S buffer A 414, and outer FEC parity symbols for Stream B may be stored in outer FEC P_S buffer B 416. The outer FEC parity symbols would remain in the buffers until the network node receives, from its link partner, an ACK message for the transmitted user data, another indication of correct data received at the link partner, or a request for the outer FEC parity symbols. If an ACK is received for a given data stream from the link partner, the associated outer FEC parity symbols may be discarded from the buffer. If an outer FEC parity symbol request is received for a given data stream from the link partner, the associated outer FEC parity symbols may be selected for transmission by MUX 418.

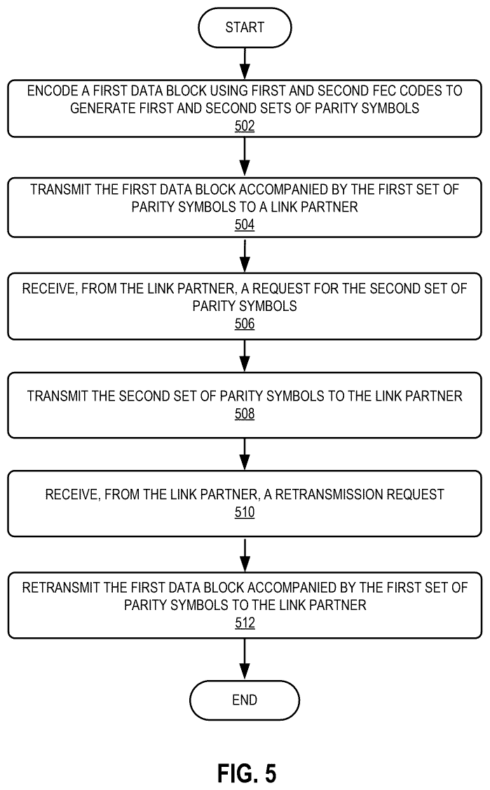

FIG. 5 presents a flowchart illustrating an example process for transmitting data on a communication link implementing multi-level FEC and link-level retransmission (LLR), according to one aspect of the instant application. All or any portion of the operations shown in FIG. 5 may be performed, for example, by logic blocks shown in FIGS. 2-4. Although the example process in FIG. 5 shows a specific order of performing certain operations, the process is not limited to such an order. Operations shown in succession in the flowchart may be performed in a different order and may be executed concurrently or with partial concurrence or combinations thereof.

The communication link may implement various communication protocols. In some aspects, the communication link may be an Ethernet link implementing an Ethernet protocol. In one aspect, the communication link may be a point-to-point link that connects two communication endpoints or nodes, one node referred to as a sender node and its link partner referred to as a receiver node. The sender and receiver are relative terms with respect to information/messages being exchanged via the communication link, where the sender sends the messages to the receiver.

During operation, the sender node may encode a first data block using the first and second FEC codes to generate the first and second sets of parity symbols, respectively (operation 502). The first and second FEC codes may provide multi-level FEC protection for the user data, with the first FEC code being a weaker code (i.e., with a higher code rate) and the second FEC code being a stronger FEC code (i.e., with a lower code rate). In other words, the first set of parity symbols may have fewer symbols than the second set of parity symbols. In one example, the first FEC code may include an RS (520, 514) code or an RS (528, 514) code, whereas the second FEC code may include an RS (544, 514) code. According to some aspects, to enhance the error-correction capacity for burst errors, the FEC encoding may be interleaved as needed. In some example, only the second or stronger FEC code is interleaved.

The first data block may include user data belonging to a first data stream. Note that multiple data streams from the sender to the receiver may participate in the same protection scheme (i.e., a scheme implementing the multi-level FEC with LLR). In one example, two data streams (namely the first and second data streams) may participate in the same protection scheme.

The sender node may transmit the first data block accompanied by the first set of parity symbols to the link partner (operation 504). Upon receiving the first data block and the first set of parity symbols, the link partner may perform a first FEC decoding operation based on the first set of parity symbols. If the number of errors in the received first data block is relatively small, the first FEC decoding operation may be able to correct all errors. In such a scenario, the link partner may respond to the sender with an ACK message and send the decoded data for further processing. If the first FEC decoding operation cannot correct all errors (e.g., the decoded data fails the FCS check or the FEC decoding indicates uncorrectable errors), the link partner may send a request for the second set of parity symbols.

The sender node receives the request for the second set of parity symbols (operation 506) and transmits the second set of parity symbols to the link partner (operation 508). This transmission does not include the first data block, thus consuming a smaller bandwidth than the original transmission. According to some aspects, after generating the first and second sets of parity symbols for a data stream, the sender node may transmit the first set of parity symbols with the user data but store the second set of parity symbols in a buffer corresponding to the data stream (e.g., buffer 414 or 416 shown in FIG. 4). The second set of parity symbols may remain in the buffer until the sender receives an ACK or other indications from the link partner indicating the successful transmission of the data stream. Upon receiving the second set of parity symbols, the receiver may perform a second FEC decoding operation to correct additional errors in the received data. If all errors are corrected, the link partner may respond to the sender with an ACK message and send the decoded data for further processing. If the second FEC decoding operation also fails to correct all errors (e.g., the decoded data fails the FCS check or the FEC decoding indicates uncorrectable errors), the link partner may send a retransmission request. In one example, the retransmission request may include an LLR NACK message or using some other indications.

The sender node receives the retransmission request (operation 510) and retransmits the first data block accompanied by the first set of parity symbols to the link partner (operation 512). The retransmitted data block may be processed by the link partner in a way similar to the initial transmission. Note that the sender may store user data belonging to different data streams in different retransmission buffers (e.g., buffers 402 and 404 shown in FIG. 4). A data block may exit the buffer responsive to the sender receiving a corresponding ACK message from the link partner.

The example shown in FIG. 5 focuses on the transmission of data in the first data stream. In practice, while the sender is waiting for an ACK or NACK message from the link partner regarding the first data stream, the sender may send data belonging to the second data stream. The independent transmission and error-correction operation of multiple data streams may enhance the effective link bandwidth.

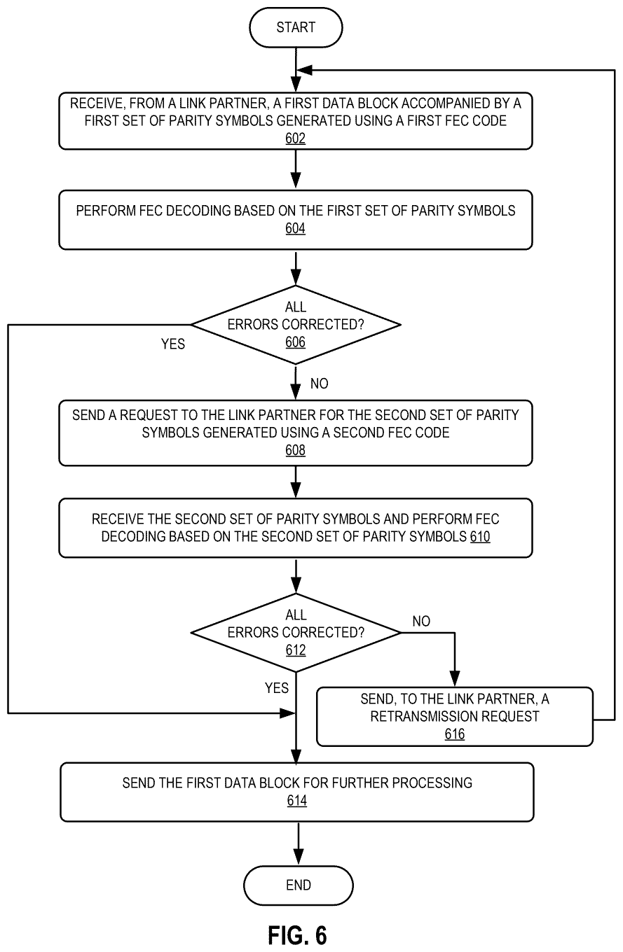

FIG. 6 presents a flowchart illustrating an example process for receiving data on a communication link implementing multi-level FEC and link-level retransmission (LLR), according to one aspect of the instant application. All or any portion of the operations shown in FIG. 6 may be performed, for example, by logic blocks shown in FIGS. 2-4. Although the example process in FIG. 6 shows a specific order for performing certain operations, the process is not limited to such an order. Operations shown in succession in the flowchart may be performed in a different order and may be executed concurrently or with partial concurrence or combinations thereof.

During operation, a receiver node may receive, from a link partner, a first data block accompanied by a first set of parity symbols (operation 602). The first set of parity symbols may be generated by the link partner using the first FEC code. The link partner may also simultaneously generate a second set of parity symbols for the first data block using a second FEC code, which is stronger (i.e., having a lower code rate) than the first FEC code. Instead of sending the second set of parity symbols to the receiver node, the link partner temporarily stores the second set of parity symbols in a data stream-specific buffer.

The receiver node may perform FEC decoding based on the first set of parity symbols (operation 604) and determine whether all errors have been corrected (operation 606). Determining whether all errors have been corrected may include performing an FCS check on the decoded data or determining whether the FEC decoding detects uncorrectable errors. If all errors have been corrected, the receiver node may send the first data block for further processing (operation 614). In one example, the communication link implements an Ethernet protocol, and the receiver node may send the error-free data block for Ethernet processing.

If there are uncorrected errors, the receiver node may send a request to the link partner for the second set of parity symbols (operation 608). The receiver node may receive the second set of parity symbols and then perform FEC decoding based on the second set of parity symbols (operation 610). Because the second FEC code is likely stronger than the first FEC code, it may be able to correct more errors than the first FEC code. In some examples, the second FEC code may be interleaved, and the receiver may need to deinterleave the received FEC codeword before performing the FEC decoding.

The receiver node may determine whether all errors have been corrected (operation 612). If so, the receiver node may send the first data block for further processing (operation 614). If there are remaining errors (e.g., the decoded data fails the FCS check or the FEC decoding detects uncorrectable errors), the receiver node may send a retransmission request to the link partner (operation 616) and subsequently receive the retransmitted first data block and first set of parity symbols (operation 602). The operations shown in FIG. 6 may be repeated for each transmitted codeword.

The example shown in FIG. 6 focuses on receiving data belonging to the first data stream. In practice, while the receiver node is waiting for the transmission of the second set of parity symbols or the retransmission of the original data from the link partner regarding the first data stream, the receiver may receive data belonging to the second data stream and perform the appropriate FEC decoding.

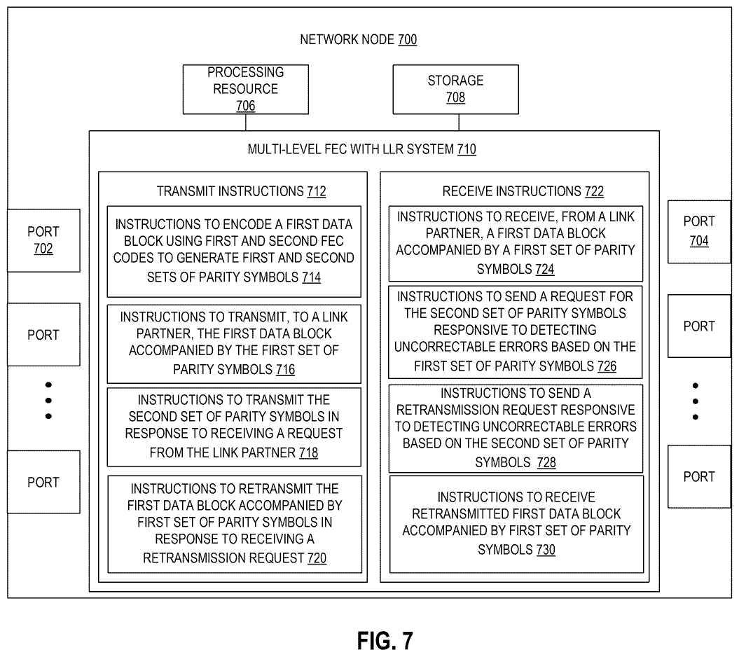

FIG. 7 illustrates an example network node implementing multi-level FEC and LLR, according to one aspect of the instant disclosure. In FIG. 7, network node 700 may include any physical devices that allow hardware on a computer network to communicate and interact with one another. The term “network node” may refer to one or more computing devices configured to emulate one or more, or all, of the functions described herein. A “computing device” may be a server, a cluster of servers, a storage array, a computer appliance, a workstation, a desktop computer, a laptop computer, a switch, a router, or any other processing device or equipment including a processing resource.

In the example shown in FIG. 7, network node 700 may include a number of communication ports, such as ports 702 and 704, for communicating with other network nodes. Network node 700 may include one or more processing resources (e.g., processing resource 706), one or more storage devices (e.g., storage device 708), and a multi-level FEC with LLR system 710. Network node 700 may include fewer or more entities than those shown in FIG. 7.

In the examples described herein, a processing resource may include, for example, one processor or multiple processors included in a single computing device or distributed across multiple computing devices. In some examples, the concurrent processes may be executed on a single computing device or multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Multi-level FEC with LLR system 710 may include any number of software units, hardware units, and firmware units that work together to achieve the goal of reducing the FEC latency and increasing the effective link bandwidth. According to some aspects, multi-level FEC with LLR system 710 may include instructions, which when executed by processing resource 706 may cause processing resource 706 to perform methods and/or processes described in this disclosure. Specifically, multi-level FEC with LLR system 710 may include transmit instructions 712 to transmit data to a link partner and receive instructions 722 to receive data from the link partner.

Transmit instructions 712 may include instructions 714 to encode a first data block using first and second FEC codes to generate first and second sets of parity symbols, respectively, as described above in relation to operation 502 shown in FIG. 5. According to some aspects, the first and second FEC codes may include RS codes, with the second FEC code likely being a stronger code than the first FEC code. Encoding the first data block using the first and second FEC codes may also include interleaving the FEC codewords. The first and second FEC encoding operations may be performed simultaneously by two FEC encoders (e.g., encoders 410 and 412 shown in FIG. 4).

Transmit instructions 712 may include instructions 716 to transmit, to a link partner, the first data block accompanied by the first set of parity symbols, as described above in relation to operation 504 shown in FIG. 5. While the first set of parity symbols are transmitted along with the data, the second set of parity symbols are not transmitted and may be stored in a buffer (e.g., buffer 414 or 416 shown in FIG. 4) within network node 700.

Transmit instructions 712 may include instructions 718 to transmit the second set of parity symbols in response to receiving a request from the link partner, as described above in relation to operations 506 and 508 shown in FIG. 5. When the link partner detects errors that cannot be corrected based on the outcome of the FEC decoding operation, it may send a request for the second set of parity symbols.

Transmit instructions 712 may include instructions 720 to retransmit the first data block accompanied by the first set of parity symbols in response to receiving a retransmission request from the link partner, as described above in relation to operations 510 and 512 shown in FIG. 5. When the link partner detects errors that cannot be corrected based on the second set of parity symbols, it may send a retransmission request (e.g., an LLR NACK).

Receive instructions 722 may include instructions 724 to receive, from a link partner, a first data block accompanied by a first set of parity symbols, as described above in relation to operation 602 shown in FIG. 6.

Receive instructions 722 may include instructions 726 to send a request for the second set of parity symbols responsive to detecting uncorrectable errors based on the first set of parity symbols, as described above in relation to operations 604-608 shown in FIG. 6. More specifically, instructions 726 may include FEC decoding instructions and parity-symbol-request-generation instructions.

Receive instructions 722 may include instructions 728 to send a retransmission request responsive to detecting uncorrectable errors based on the second set of parity symbols, as described above in relation to operations 604-608 shown in FIG. 6. More specifically, instructions 728 may include FEC decoding instructions and retransmission-request-generation instructions.

Receive instructions 722 may include instructions 730 to receive retransmitted first data block accompanied by a first set of parity symbols, as described above in relation to operation 602 shown in FIG. 6.

Multi-level FEC with LLR system 710 may include more instructions than those shown in FIG. 7. For example, transmit instructions 712 may include instructions for transmitting data blocks and parity symbols belonging to different data streams sequentially in an order based on availability and/or FEC interleaving.

In general, aspects of the disclosure provide a multi-level FEC solution combined with LLR to reduce the BER on a communication link without significantly affecting the effective link bandwidth. Multiple independent data streams transmitted from a sender node to a receiver node may participate in the same protection scheme combining multi-level FEC and LLR, with each data stream being encoded using both a lower-level or weaker FEC code and likely a higher-level or stronger FEC code. The initial transmission of a data stream may include user data along with the parity symbols of the lower-level FEC to allow the receiver to correct errors based on the lower-level FEC parity symbols. If the data stream fails the FCS check at the receiver, the transmitter may receive a request to send the parity symbols of the higher-level FEC. If the higher-level FEC still fails to correct all errors, the receiver may send an LLR NACK to the transmitter, requesting the retransmission of the inner FEC encoded user data. While the receiver is waiting for the higher-level FEC parity symbols and/or retransmission of one data stream, it may receive and/or process other data streams normally, thus further enhancing the effective bandwidth of the communication link.

One aspect of the instant application provides a system and method for improving data transmission reliability. During operation, a network node may encode a first data block using first and second Forward Error Correction (FEC) codes to generate, respectively, first and second sets of parity symbols and transmit, over a data link, the first data block accompanied by the first set of parity symbols to a link partner. In response to receiving, from the link partner, a request for the second set of parity symbols, the network node may transmit the second set of parity symbols to the link partner. In response to receiving, from the link partner, a retransmission request, the network node may retransmit the first data block accompanied by the first set of parity symbols to the link partner. The link partner may be configured to decode received data based on the first FEC code and the first set of parity symbols and may send a request for the second set of parity symbols in response to the first FEC decoding detecting uncorrectable errors.

In a variation on this aspect, the second FEC code may be stronger than the first FEC code, or the second set of parity symbols may be longer than the first set of parity symbols. For example, the second FEC code may have a lower code rate than the first FEC code.

In a variation on this aspect, the first or second FEC code may include a Reed-Solomon (RS) code. For example, the first FEC code may include an RS (520, 514) code or an RS (528, 514) code, whereas the second FEC code may include an RS (544, 514) code.

In a variation on this aspect, the data link may implement link-level retransmission (LLR), and the retransmission request may include an LLR negative acknowledgment (NACK) message. For example, the link partner may be configured to perform second FEC decoding based on the second set of parity symbols. If the decoded data fails the FCS check or the second FEC decoding indicates uncorrectable errors, the link partner may send an LLR NACK.

In a further variation, the network node may receive the LLR NACK message from the link partner in response to the link partner detecting uncorrectable errors in the first data block based on the second set of parity symbols. The link partner may detect uncorrectable errors if the FEC decoding indicates uncorrectable errors, or the decoded data fails the FCS check.

In a variation on this aspect, the first data block may be associated with a first data stream, and the network node may encode and transmit, to the link partner, a second data block associated with a second data stream. Allowing multiple independent data streams to participate in the multi-level FEC protection scheme may improve the data transmission efficiency.

In a further variation, the first data block, the second data block, and the second set of parity symbols may be transmitted sequentially in an order based on availability. Data blocks belonging to different data streams may be transmitted in an interleave manner, with no ordering constraints between these different data streams.

In a variation on this aspect, the request for the second set of parity symbols is received from the link partner in response to the link partner detecting uncorrectable errors in the first data block based on the first set of parity symbols.

One aspect of the instant application provides a network node. The network node may include a first Forward Error Correction (FEC) encoder to encode a first data block using a first FEC code to generate a first set of parity symbols, a second FEC encoder to encode the first data block using a second FEC code to generate a second set of parity symbols, and a transmitter to transmit, over a data link, the first data block accompanied by the first set of parity symbols to a link partner. In response to receiving, from the link partner, a request for the second set of parity symbols, the transmitter may transmit the second set of parity symbols to the link partner. In response to receiving, from the link partner, a retransmission request, the transmitter may retransmit the first data block accompanied by the first set of parity symbols to the link partner.

One aspect of the instant application provides a system and method for improving data transmission reliability. During operation, a network node may receive, from a link partner, a first data block accompanied by a first set of parity symbols generated using a first Forward Error Correction (FEC) code. In response to detecting uncorrectable errors in the first data block based on the first set of parity symbols, the network node may send a request to the link partner to request a second set of parity symbols generated using a second FEC code and receive the second set of parity symbols. In response to detecting uncorrectable errors in the first data block based on the second set of parity symbols, the network node may send a retransmission request to the link partner and receive retransmitted first data block accompanied by the first set of parity symbols.

In this disclosure, the functions include a plurality of logic units capable of performing predetermined logic function described throughout the disclosure. The functions shown in FIGS. 5 and 6 may be implemented using any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various functions described herein might be implemented as discrete circuits or the functions and features described can be shared in part or in total among one or more circuits. Even though various features or elements of functionality may be individually described or claimed as separate functions, these features and functionality can be shared among one or more common functions, and such description shall not require or imply that separate circuits are required to implement such features or functionality.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method, comprising:
encoding a first data block using first and second Forward Error Correction (FEC) codes to generate, respectively, first and second sets of parity symbols;
transmitting, over a data link, the first data block accompanied by the first set of parity symbols to a link partner;
in response to receiving, from the link partner, a request for the second set of parity symbols, transmitting the second set of parity symbols to the link partner; and
in response to receiving, from the link partner, a retransmission request, retransmitting the first data block accompanied by the first set of parity symbols to the link partner.

2. The method of claim 1, wherein:
the second FEC code is stronger than the first FEC code; or
the second set of parity symbols is longer than the first set of parity symbols.

3. The method of claim 1, wherein the first or second FEC code comprises a Reed-Solomon (RS) code.

4. The method of claim 1, wherein the data link implements link-level retransmission (LLR), and wherein the retransmission request comprises an LLR negative acknowledgment (NACK) message.

5. The method of claim 4, further comprising receiving the LLR NACK message from the link partner in response to the link partner detecting uncorrectable errors in the first data block based on the second set of parity symbols.

6. The method of claim 1,
wherein the first data block is associated with a first data stream, and
wherein the method further comprises encoding and transmitting, to the link partner, a second data block associated with a second data stream.

7. The method of claim 6, wherein the first data block, the second data block, and the second set of parity symbols are transmitted sequentially in an order based on availability.

8. The method of claim 1, wherein the request for the second set of parity symbols is received from the link partner in response to the link partner detecting uncorrectable errors in the first data block based on the first set of parity symbols.

9. A network node, comprising:
a first Forward Error Correction (FEC) encoder to encode a first data block using a first FEC code to generate a first set of parity symbols;
a second FEC encoder to encode the first data block using a second FEC code to generate a second set of parity symbols; and
a transmitter to:
transmit, over a data link, the first data block accompanied by the first set of parity symbols to a link partner;
in response to receiving, from the link partner, a request for the second set of parity symbols, transmit the second set of parity symbols to the link partner; and
in response to receiving, from the link partner, a retransmission request, retransmitting the first data block accompanied by the first set of parity symbols to the link partner.

10. The network node of claim 9, wherein:
the second FEC code is stronger than the first FEC code; or
the second set of parity symbols is longer than the first set of parity symbols.

11. The network node of claim 9, wherein the first or second FEC code comprises a Reed-Solomon (RS) code.

12. The network node of claim 9, wherein the data link implements link-level retransmission (LLR), and wherein the retransmission request comprises an LLR negative acknowledgment (NACK) message.

13. The network node of claim 12, wherein the LLR NACK message is received from the link partner in response to the link partner detecting uncorrectable errors in the first data block encoded based on the second set of parity symbols.

14. The network node of claim 9,
wherein the first data block is associated with a first data stream, and
wherein the method further comprises encoding and transmitting a second data block associated with a second data stream to the link partner.

15. The network node of claim 14, wherein the transmitter is to transmit the first data block, the second data block, and the second set of parity symbols sequentially in an order based on availability.

16. The network node of claim 9, wherein the request for the second set of parity symbols is received from the link partner in response to the link partner detecting uncorrectable errors in the first data block based on the first set of parity symbols.

17. A method, comprising:
receiving, at a network node from a link partner, a first data block accompanied by a first set of parity symbols generated using a first Forward Error Correction (FEC) code;
in response to detecting uncorrectable errors in the first data block based on the first set of parity symbols, sending a request to the link partner to request a second set of parity symbols generated using a second FEC code;
receiving the second set of parity symbols;
in response to detecting uncorrectable errors in the first data block based on the second set of parity symbols, sending a retransmission request to the link partner; and
receiving retransmitted first data block accompanied by the first set of parity symbols.

18. The method of claim 17, wherein the second FEC code is stronger than the first FEC code, and wherein the second set of parity symbols is longer than the first set of parity symbols, and wherein the first or second FEC code comprises a Reed-Solomon (RS) code.

19. The method of claim 17, wherein the data link implements link-level retransmission (LLR), and wherein the retransmission request comprises an LLR negative acknowledgment (NACK) message.

20. The method of claim 17, wherein the first data block is associated with a first data stream, and
wherein the method further comprises receiving, from the link partner, a second data block associated with a second data stream.
